(19) United States
(12) Patent Application Publication
(10) Pub. No.: US 2023/0299424 A1
(43) Pub. Date: Sep. 21, 2023

(54) ALL SOLID STATE BATTERY

(71) Applicant: SAMSUNG ELECTRO-MECHANICS CO., LTD., Suwon-si, Gyeonggi-do (KR)

(72) Inventors: Tae-Hoon KIM, Suwon-si, Gyeonggi-do (KR); Seung-Jin PARK, Suwon-si, Gyeonggi-do (KR); Nam-Gyu KIM, Suwon-si, Gyeonggi-do (KR); Jeong-Wook KIM, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/021,668

(22) PCT Filed: Sep. 16, 2021
(86) PCT No.: PCT/KR2021/012670

§ 371 Date: Feb. 16, 2023

(30) Foreign Application Priority Data
Dec. 31, 2020 (KR) 10-2020-0189784

(51) Int. Cl. H01M 50/46; H01M 50/54; H01M 10/0585

(52) U.S. Cl. CPC H01M 50/46; H01M 50/54; H01M 10/0585

(57) ABSTRACT

An all-solid-state battery includes a battery body having first and second surfaces in a first direction, third and fourth surfaces in a second direction, and fifth and sixth surfaces in a third direction. The battery body including a solid electrolyte layer, and an electrode assembly in which a positive electrode layer and a negative electrode layer are stacked in the third direction, a first positive terminal disposed on the first surface and connected to the positive electrode layer, and a first negative terminal also disposed on the first surface but connected to the negative electrode layer. The positive electrode layer includes a first positive electrode lead portion extending from the positive electrode layer and connected to the first positive terminal, and the negative electrode layer includes a first negative electrode lead portion extending from the negative electrode layer and connected to the first negative terminal.

### TECHNICAL FIELD

The present disclosure relates to an all-solid-state battery.

### BACKGROUND ART

Recently, devices using electricity as an energy source have been increasing. As devices using electricity such as smartphones, camcorders, notebook PCs, and electric vehicles expand, interest in electrical storage devices using electrochemical devices is increasing. Among various electrochemical devices, lithium secondary batteries that are capable of charging and discharging electricity, having a high operating voltage, and extremely high energy density, are in the spotlight.

A lithium secondary battery is manufactured by applying a material capable of insertion and desorption of lithium ions to a positive electrode and a negative electrode and injecting a liquid electrolyte between the positive electrode and the negative electrode, and electricity is generated or consumed by an oxidation reduction reaction according to the insertion and desorption of lithium ions in the negative electrode and the positive electrode. Such a lithium secondary battery should be basically stable in an operating voltage range of the battery, and should have performance capable of transferring ions at a sufficiently high speed.

When a liquid electrolyte such as a non-aqueous electrolyte is used in such a lithium secondary battery, there is an advantage in that the discharge capacitance and the energy density are high. However, the lithium secondary battery has problems in that it is difficult to implement a high voltage therewith, and there is a high risk of electrolyte leakage, fire, and explosion.

In order to solve the above problem, a secondary battery to which a solid electrolyte is applied instead of a liquid electrolyte has been proposed as an alternative. The solid electrolyte may be divided into a polymer-based solid electrolyte and a ceramic-based solid electrolyte, and thereamong, the ceramic-based solid electrolyte has an advantage of high stability. Research is underway to apply such ceramic-based solid electrolyte batteries to various fields, and demand for a solid electrolyte battery having sufficient capacitance while satisfying mechanical reliability is increasing.

### DISCLOSURE OF INVENTION

### Technical Problem

An aspect of the present disclosure is to provide an all-solid-state battery in which defects due to an internal step difference may be prevented.

An aspect of the present disclosure is to provide an all-solid-state battery capable of miniaturization and having sufficient capacitance.

An aspect of the present disclosure is to provide an all-solid-state battery having improved mechanical reliability.

### Solution to Problem

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

According to an aspect of the present disclosure, an all-solid-state battery includes a battery body having first and second surfaces opposing each other in a first direction, third and fourth surfaces opposing each other in a second direction, and fifth and sixth surfaces opposing each other in a third direction, the battery body including a solid electrolyte layer, and an electrode assembly in which a positive electrode layer and a negative electrode layer are stacked in the third direction with the solid electrolyte layer interposed therebetween; a first positive terminal connected to the positive electrode layer; and a first negative terminal connected to the negative electrode layer. The first positive terminal is disposed on the first surface of the electrode assembly, the first negative terminal is disposed on the first surface of the electrode assembly and spaced apart from the first positive terminal, the positive electrode layer includes a first positive electrode lead portion extending from the positive electrode layer and connected to the first positive terminal on the first surface of the electrode assembly, and the negative electrode layer includes a first negative electrode lead portion extending from the negative electrode layer and connected to the first negative terminal on the first surface of the electrode assembly.

According to an aspect of the present disclosure, an all-solid-state battery includes a battery body having first and second surfaces opposing each other in a first direction, third and fourth surfaces opposing each other in a second direction, and fifth and sixth surfaces opposing each other in a third direction. The battery body may include a solid electrolyte layer, and an electrode assembly in which a positive electrode layer and a negative electrode layer am stacked in the third direction with the solid electrolyte layer interposed therebetween. The positive electrode layer may include a first positive electrode lead portion extending from the positive electrode layer to the first surface of the electrode assembly, the first positive electrode lead portion arranged to be connected to a first positive terminal. The negative electrode layer may include a first negative electrode lead portion extending from the negative electrode layer to the first surface of the electrode assembly and spaced apart from the first positive electrode lead portion, the first negative electrode lead portion arranged to be connected to a first negative terminal.

### Advantageous Effects of Invention

According to an embodiment, an all-solid-state battery in which defects due to an internal step difference may be prevented may be provided.

An all-solid-state battery capable of miniaturization and having sufficient capacitance may be provided.

An all-solid-state battery having improved mechanical reliability may be provided.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a perspective view schematically illustrating an all-solid-state battery according to an embodiment of the present disclosure:

FIG. 2 is a perspective view schematically illustrating a battery body of FIG. 1;

FIG. 3 is a cross-sectional view taken along line I-I′ of FIG. 1;

FIGS. 4A and 4B are plan views schematically illustrating a positive electrode layer and a negative electrode layer of a multilayer ceramic electronic component of FIG. 1;

FIG. 5 is a perspective view schematically illustrating an all-solid-state battery according to another embodiment of the present disclosure:

FIGS. 6A and 6B are plan views schematically illustrating a positive electrode layer and a negative electrode layer of a multilayer ceramic electronic component of FIG. 5;

FIG. 7 is a perspective view schematically illustrating an all-solid-state battery according to another embodiment of the present disclosure;

FIGS. 8A and 8B are plan views schematically illustrating a positive electrode layer and a negative electrode layer of a multilayer ceramic electronic component of FIG. 7;

FIG. 9 is a perspective view schematically illustrating an all-solid-state battery according to another embodiment;

FIGS. 10A and 10B are plan views schematically illustrating a positive electrode layer and a negative electrode layer of a multilayer ceramic electronic component of FIG. 9;

FIG. 11 is a perspective view schematically illustrating an all-solid-state battery according to another embodiment; and

FIGS. 12A and 12B are plan views schematically illustrating a positive electrode layer and a negative electrode layer of a multilayer ceramic electronic component of FIG. 11.

### MODE FOR THE INVENTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an embodiment or example, e.g., as to what an embodiment or example may include or implement, means that at least one embodiment or example exists in which such a feature is included or implemented while all examples and examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other manners (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes.” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various manners as will be apparent after gaining an understanding of the disclosure of this application. Further, although the examples described herein have a variety of configurations, other configurations are possible as will be apparent after gaining an understanding of the disclosure of this application.

The drawings may not be to scale, and the relative sizes, proportions, and depiction of elements in the drawings may be exaggerated for clarity, illustration, and convenience.

In this specification, expressions such as “A and/or B”, “at least one of A and B”, or “one or more of A and B” may include all possible combinations of the items listed together. For example, “A and/or B”, “at least one of A and B”, or “one or more of A and B” means (1) includes at least one A; (2) at least one It may refer to both cases including B, or (3) including both at least one A and at least one B.

In the drawings, an X direction may be defined as a first direction, an L direction or a length direction, a Y direction may be defined as a second direction, a W direction or a width direction, and a Z direction may be defined as a third direction, a T direction, or a thickness direction.

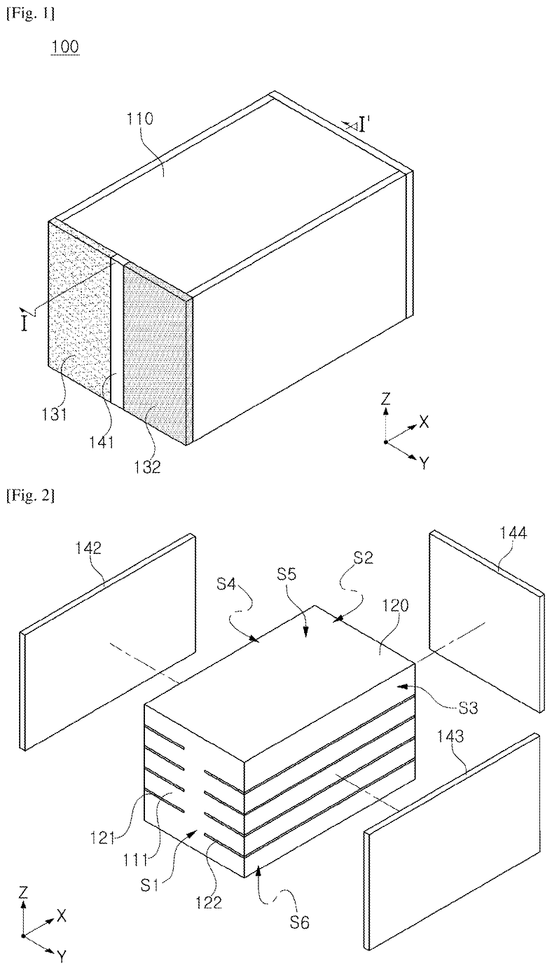

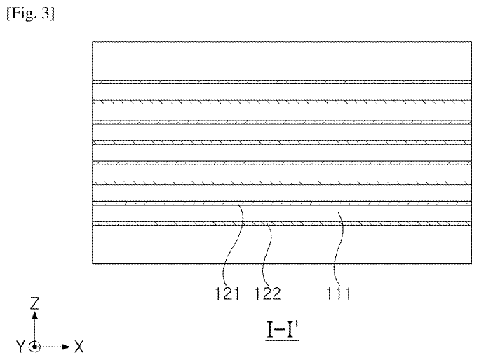

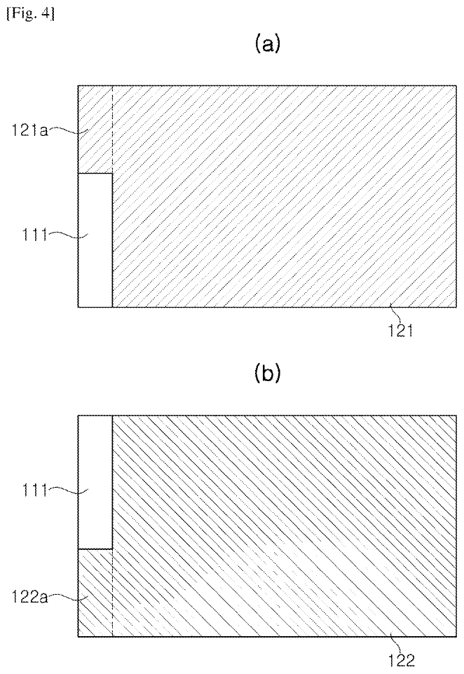

An all-solid-state battery 100 according to an embodiment is provided. FIGS. 1 to 4B are views schematically illustrating an all-solid-state battery 100 according to an embodiment. Referring to FIGS. 1 to 4B, the all-solid-state battery 100 according to an embodiment may include a battery body having first and second surfaces opposing each other in a first direction, third and fourth surfaces opposing each other in a second direction, and fifth and sixth surfaces opposing each other in a third direction, the battery body including a solid electrolyte layer, and an electrode assembly in which a positive electrode layer 121 and a negative electrode layer 122 are stacked in a third direction with the solid electrolyte layer interposed therebetween; a first positive terminal connected to the positive electrode layer 121; and a first negative terminal connected to the negative electrode layer 122.

In this case, the first positive terminal may be disposed on a first surface of the electrode assembly, and the first negative terminal may be disposed on the first surface of the electrode assembly to be spaced apart from the first positive terminal. In addition, the positive electrode layer 121 may include a first positive electrode lead portion 121a extending from the positive electrode layer 121 and connected to the first positive terminal on the first surface of the electrode assembly, and the negative electrode layer 122 may include a first negative electrode lead portion 122a extending from the negative electrode layer 122 and connected to the first negative terminal on the first surface of the electrode assembly.

In an all-solid-state battery of the related art, an electrode assembly formed by stacking a plurality of solid electrolyte layers on which a positive electrode layer and a negative electrode layer are printed is used, as in the case of an existing passive device. As the demand for high-capacitance batteries increases, naturally, batteries with an increased number of stacked layers have begun to be manufactured. However, in the case of the above structure, a difference in thickness occurs between the printed area and the unprinted area of the positive electrode layer and the negative electrode layer. In detail, in an all-solid-state battery using a positive electrode layer and a negative electrode layer thicker than those of existing passive devices, the step difference due to the thickness of the positive electrode layer and the negative electrode layer becomes nonnegligible, and cracks may occur in the battery due to the accumulated internal step difference, or there is a problem in that the strength of the battery itself may be lowered. Meanwhile, the all-solid-state battery according to an embodiment of the present disclosure has a structure in which the positive electrode layer 121 and the negative electrode layer 122 are led out to the same surface of the battery body, and the positive and negative terminals are directly connected to the positive and negative electrodes respectively, thereby significantly reducing an adverse effect caused by an internal step.

A battery body 110 of the all-solid-state battery 100 according to an embodiment of the present disclosure may include a solid electrolyte layer 111, the positive electrode layer 121, and the negative electrode layer 122.

In an embodiment of the present disclosure, the solid electrolyte layer 111 according to an embodiment may be at least one selected from the group consisting of Garnet-type, Nasicon-type, LISICON-type, perovskite-type and LiPON-type.

The Garnet-type solid electrolyte may indicate lithium-lanthanum zirconium oxide (LLZO) represented by LiₐLa_{b}Zr_{c}O₁₂, such as Li₇La₃Zr₂O₁₂. The Nasicon-based solid electrolyte may indicate lithium-aluminum-titanium-phosphate (LATP) of Li₁₊ₓAlₓTi₂₋ₓ(PO₄)₃ (0<x<1) in which Ti is introduced into Li₁₊ₓAlₓM₂₋ₓ(PO₄)₃(LAMP) (0<x<2, M=Zr, Ti, Ge)-based compound, and indicate lithium-aluminum-germanium-phosphate (LAGP) represented by Li₁₊ₓAlₓGe₂₋ₓ(PO₄)₃(O<x<1), such as Li_{1.3}Al_{0.3}Ti_{1.7}(PO₄)₃, in which an excess amount of lithium is introduced, and/or lithium-zirconium-phosphate (LZP) of LiZr₂(PO₄)₃.

In addition, the LISICON-based solid electrolyte may indicate solid solution oxide represented by xLi₃AO₄-(1−x)Li₄BO₄ (A: P, As, V or the like, B: Si, Ge, Ti or the like) and including Li₄Zn(GeO₄)₄, Li₁₀GeP₂O₁₂(LGPO), Li_{3.5}Si_{0.5}P_{0.5}O₄, Li_{10.42}Si(Ge)_{1.5}P_{1.5}Cl_{0.08}O_{11.92}, or the like, and solid solution sulfide including Li₂S—P₂S₅, Li₂S—SiS₂, Li₂S—SiS₂—P₂S₅, Li₂S—GeS₂, or the like, represented by Li₄₋ₓM_{1-y}M′_{y}′S₄ (M=Si, Ge and M′=P, Al, Zn, Ga).

The perovskite-based solid electrolyte may refer to lithium-lanthanum-titanate-oxide (lithium lanthanum titanate, LLTO) represented by Li₃ₓLa_{2/3-x□1/3-2x}TiO₃(0<x<0.16, vacancy), such as Li_{1/8}La_{5/8}TiO₃ or the like, and the LiPON-based solid electrolyte may refer to a nitride such as lithium phosphorous-oxynitride of Li_{2.8}PO_{3.3}N_{0.46}, or the like.

In an example, the positive electrode layer 121 of the all-solid-state battery 100 according to an embodiment of the present disclosure may include a positive electrode current collector and a positive active material. For example, the positive electrode layer 121 of the all-solid-state battery 100 according to an embodiment may have a structure in which the positive active material is disposed on both surfaces of the positive electrode current collector in the third direction (Z direction).

The positive active material may be, for example, a compound represented by the following formula: LiₐA_{1-b}M_{b}D₂ (where0.90≤a≤1.8, 0≤b≤0.5); LiₐE_{1-b}M_{b}O_{2-c}D_{c} (where 0.90≤a≤1.8, 0≤b≤0.5, 0≤c≤0.05); LiE_{2-b}M_{b}O_{4-c}D_{c} (where 0≤b≤0.5, 0≤c≤0.05); LiaNi_{1-b-c}Co_{b}M_{c}Dₐ(where 0.90≤a≤1.8, 0≤b≤0.5, 0≤c≤0.05, 0<α≤2); LiₐNi_{1-b-c}Co_{b}M_{c}O_{2-α}X_{α}(where 0.90≤a≤1.8, 0≤b≤0.5, 0≤c≤0.05, 0<α<2); LiₐNi_{1-b-c}Co_{b}M_{c}O_{2-α}X₂ (where 0.90≤a≤1.8, 0≤b≤0.5, 0≤c≤0.05, 0<α<2); LiₐNi_{1-b-c}Mn_{b}M_{c}D_{α}(where 0.90≤a≤1.8, 0≤b≤0.5, 0≤c≤0.05, 0<α<2); LiₐN_{1-b-c}(Mn_{b}M_{c}O₂₋ₐX_{α}(where 0.90≤a≤1.8, 0≤b≤0.5, 0≤c≤0.05, 0<α<2); LiₐN_{1-b-c}Mn_{b}M_{c}O_{2-α}X₂(where 0.90≤a≤1.8, 0≤b≤0.5, 0≤c≤0.05, 0<α<2); LiₐNi_{b}E_{c}G_{d}O₂ (where 0.90≤a≤1.8, 0≤b≤0.9, 0≤c≤0.5, 0.001≤d≤0.1); LiₐNi_{b}Co_{c}Mn_{d}GₑO₂ (where 0.90≤a≤1.8, 0≤b≤0.9, 0≤c≤0.5, 0≤d≤0.5, 0.001≤e≤0.1: LiₐNiG_{b}O₂ (where 0.90≤a≤1.8, 0.001≤b≤0.1); LiₐCoG_{b}O₂ (where 0.90≤a≤1.8, 0.001≤b≤0.1); LiₐMnG_{b}O₂ (where 0.90≤a≤1.8, 0.001≤b≤0.1); LiₐMn₂G_{b}O₄ (where 0.90≤a≤1.8, 0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ (where 0≤f≤2); and LiFe₂PO₄. In the above formula, A is Ni, Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo or Mn; R is Cr, V, Fe, Sc, or Y; J is V, Cr, Mn, Co, Ni, or Cu.

The positive active material may also be LiCoO₂, LiMnₓO₂ₓ (where x=1 or 2). LiNi₁₋ₓMnₓO₂ₓ, (where 0<x<1), LiNi_{1-x-y}CoₓMn_{y}O₂ (where 0≤x≤0.5, O≤y≤0.5), LiFePO₄, TiS₂. FeS₂, TiS₃, or FeS₃, but is not limited thereto.

As the positive electrode current collector, a porous body such as a mesh shape may be used, and a porous metal plate including a conductive metal such as stainless steel, nickel, tin, or aluminum may be used, but the positive electrode current collector is not limited thereto. In addition, the positive electrode current collector may be coated with an oxidation-resistant metal or alloy film to prevent oxidation.

The positive electrode layer 121 of the all-solid-state battery 100 according to an embodiment may optionally include a conductive agent and a binder. The conductive agent is not particularly limited as long as it has conductivity without causing a chemical change in the all-solid-state battery 100 according to an embodiment. For example, the conductive agent includes graphite, such as natural graphite and artificial graphite; a carbon-based sub≤tance such as carbon black, acetylene black, ketjen black, channel black, furnace black, lamp black, and thermal black; a conductive fiber such as carbon fibers and metal fibers; carbon fluoride: metal powder such as aluminum and nickel powder; conductive whisker such as zinc oxide and potassium titanate; conductive metal oxide such as titanium oxide; a conductive material such as polyphenylene derivatives.

The binder may be used to improve bonding strength between the active material and the conductive agent or the like. The binder may be polyvinylidene fluoride, polyvinyl alcohol, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene terpolymer (EPDM), sulfonated EPDM, styrene butadiene rubber, fluororubber, and various copolymers, but is not limited thereto.

In an example of the present disclosure, the positive electrode layer 121 of the all-solid-state battery may further include a solid electrolyte component. The solid electrolyte component may be one or more of the above components and may function as an ion conduction channel in the positive electrode layer 121. Thereby, the interface resistance may be reduced.

The positive electrode layer 121 applied to the all-solid-state battery 100 according to an embodiment may be prepared by directly coating and drying a composition including a positive active material on a positive electrode current collector including a metal such as copper. Alternatively, the positive active material composition may be cast on a separate support and then cured to prepare the positive electrode layer 121, and in this case, a separate positive electrode current collector may not be included.

The negative electrode layer 122 of the all-solid-state battery 100 according to an embodiment may include a negative electrode current collector and a negative active material. For example, the negative electrode layer 122 of the all-solid-state battery 100 according to an embodiment may have a structure in which the negative active material is disposed on both surfaces of the negative electrode current collector in the third direction (Z direction).

The negative electrode included in the all-solid-state battery 100 according to an embodiment may include a commonly used negative active material. As the negative active material, a carbon-based material, silicon, silicon oxide, a silicon-based alloy, a silicon-carbon-based material composite, tin, a tin-based alloy, tin-carbon composite, metal oxide, or combinations thereof may be used, and a lithium metal and/or lithium metal alloy may be included.

The lithium metal alloy may include lithium and a metal/metalloid capable of alloying with lithium. For example, the metal/metalloid capable of alloying with lithium may be Si, Sn, Al, Ge, Pb, Bi, Sb, a Si—Y alloy (where Y is an alkali metal, alkaline earth metal, group 13 to 16 element, transition metal, rare earth element, or combination elements thereof, and does not contain Si), a Sn—Y alloy (where Y is an alkali metal, alkaline earth metal, group 13 to 16 element, transition metal, transition metal oxide such as lithium titanium oxide (Li₄Ti₅O₁₂), rare earth element, or combination elements thereof, and does not contain Sn), MnOₓ, (0<x<2), and the like. As the element Y, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or combinations thereof may be used.

In addition, the oxide of the metal/metalloid alloyable with lithium may be lithium titanium oxide, vanadium oxide, lithium vanadium oxide. SnO₂, SiOₓ(0<x<2), or the like. For example, the negative active material may include at least one element selected from the group consisting of elements from Groups 13 to 16 of the Periodic Table of Elements. For example, the negative active material may include one or more elements selected from the group consisting of Si, Ge, and Sn.

The carbon-based material may be crystalline carbon, amorphous carbon, or a mixture thereof. The crystalline carbon may be graphite such as amorphous, plate-like, flake-like, spherical or fibrous natural graphite or artificial graphite. In addition, the amorphous carbon may be soft carbon (low temperature calcined carbon) or hard carbon, mesophase pitch carbide, calcined coke, graphene, carbon black, fullerene soot, a carbon nanotube, a carbon fiber, or the like, but is not limited thereto.

The silicon may be selected from the group consisting of Si, SiOₓ (0<x<2, for example, 0.5 to 1.5), Sn, SnO₂, or silicon-containing metal alloys and mixtures thereof. The silicon-containing metal alloy may include, for example, silicon and at least one of Al, Sn, Ag, Fe, Bi, Mg. Zn, in, Ge. Pb and Ti.

The negative electrode current collector of the all-solid-state battery 100 according to an embodiment may have the same configuration as the positive electrode current collector. The negative electrode current collector may use, for example, a porous body such as a mesh shape, and may use a porous metal plate such as stainless steel, nickel, or aluminum, but is not limited thereto. In addition, the negative electrode current collector may be coated with an oxidation-resistant metal or alloy film to prevent oxidation.

The negative electrode layer 122 may be manufactured according to almost the same method as the above-described positive electrode manufacturing method, except for using the negative active material instead of the positive active material.

In an example of the present disclosure, the negative electrode layer 122 of the all-solid-state battery may further include a solid electrolyte component. The solid electrolyte component may use one or more of the above components, and may function as an ion conduction channel in the negative electrode layer 122. Thereby, interface resistance may be reduced.

In an embodiment of the present disclosure, in the electrode assembly of the all-solid-state battery, the positive electrode layer 121 and the negative electrode layer 122 may be exposed to the second to fourth surfaces (i.e., the second, third and fourth surfaces) of the electrode assembly. Also, the positive electrode lead portion and the negative electrode lead portion may be exposed on the first surface of the electrode assembly. For example, the positive electrode layer 121 and the negative electrode layer 122 may be exposed together on both surfaces of the electrode assembly in the first direction and both surfaces thereof in the second direction. The structure may be a structure in which a margin is not disposed in a region parallel to the positive electrode layer 121 and the negative electrode layer 122. In the case of the related art, a positive electrode layer and a negative electrode layer having a smaller area than a solid electrolyte layer is formed, and an area in which the positive electrode layer and the negative electrode layer am not disposed is used as a margin portion. Due to the presence of the margin portion, a thickness step corresponding to the thickness of the positive electrode layer and the negative electrode layer is generated. In the case of the all-solid-state battery according to an embodiment of the present disclosure, the electrode assembly is formed without having a separate margin, thereby preventing the problem caused by a thickness step difference.

In an embodiment of the present disclosure, the battery body of the all-solid-state battery may include an insulating member (142, 143, 144) disposed on a second surface, a third surface, and a fourth surface of the electrode assembly. The insulating member may be disposed to protect the positive electrode layer 121 and the negative electrode layer 122 exposed to four surfaces of the electrode assembly, and may include an insulating material.

In an example of the present disclosure, the insulating member of the all-solid-state battery may be disposed to completely cover the positive electrode layer 121 and the negative electrode layer 122 led out to the second to fourth surfaces of the electrode assembly. In this specification, that the first member is disposed to “cover” the second member may indicate that the first member is disposed so that a portion of the second member covered by the first member is not exposed externally, and that the second member is hidden by the first member so that the second member is not visible. In the all-solid-state battery according to an embodiment of the present disclosure, by disposing the insulating member on the surface of the electrode assembly on which the margin is not disposed, the problem of the thickness step difference may be prevented from occurring and the intrusion of external moisture or contaminants may be prevented.

In an example, the insulating member of the all-solid-state battery may include a ceramic material, for example, alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), mixtures thereof, oxides and/or nitrides of these materials, or any other suitable ceramic material, but the material thereof is not limited thereto. In addition, the insulating member may optionally include the aforementioned solid electrolyte, and may include one or more solid electrolytes, but the configuration is not limited thereto. The insulating member may be formed by applying a slurry including a ceramic material to the surfaces of the battery cells, the present disclosure is not limited thereto. The insulating member may basically serve to prevent damage to the electrode assembly due to physical or chemical stress.

In another example, the insulating member of the all-solid-state battery according to an embodiment of the present disclosure may include a resin component. The resin component may be, for example, a thermosetting resin, and the thermosetting resin may indicate a resin that may be cured through an appropriate heat application or aging process. Detailed examples of the thermosetting resin may include phenol resin, urea resin, diallyl phthalate resin, melanin resin, guanamine resin, unsaturated polyester resin, polyurethane resin, epoxy resin, aminoalkyd resin, melamine-urea cocondensation resin, silicon resin, polysiloxane resin, and the like, but are not limited thereto. When using a thermosetting resin, a crosslinking agent, a curing agent such as a polymerization initiator, a polymerization accelerator, a solvent, a viscosity modifier, or the like may be further added and used as needed. The insulating member may be formed by transfer molding a resin such as epoxy molding compound (EMC) to surround the electrode assembly, but the configuration is not limited thereto.

The positive electrode layer 121 of the all-solid-state battery according to an embodiment may include a positive electrode lead portion, and the negative electrode layer 122 may include a negative electrode lead portion. The positive electrode lead portion is an extension of the positive electrode layer 121, and the positive electrode lead portion according to an embodiment may have a single structure with the positive electrode layer 121. The negative electrode lead portion is an extension of the negative electrode layer 122, and the negative electrode lead portion according to an embodiment may have a single structure with the negative electrode layer 122.

In an example of the present disclosure, the positive electrode layer 121 of the allsolid-state battery may include the first positive electrode lead portion 121a, and the negative electrode layer 122 may include the first negative electrode lead portion 122a. The first positive electrode lead portion 121a may be connected to the first positive terminal disposed on the first surface of the electrode assembly, and the first negative electrode lead portion 122a may be connected to a second negative terminal disposed on the first surface of the electrode assembly. The positive terminal and the negative terminal may be disposed on the first surface of the electrode assembly and spaced apart from each other. Referring to FIGS. 1 to 4B, in the all-solid-state battery according to this example, both the positive electrode lead portion and the negative electrode lead portion may be led out through the first surface of the electrode assembly.

The all-solid-state battery according to an embodiment may include a positive terminal connected to the positive electrode layer 121 and a negative terminal connected to the negative electrode layer 122. The positive terminal may include a first positive terminal, and the negative terminal may include a first negative terminal.

In an example of the present disclosure, the first positive terminal of the all-solid-state battery may be disposed to cover at least a portion of the first positive electrode lead portion 121a, and the first negative terminal may be disposed to cover at least a portion of the first negative electrode lead portion 122a. Referring to FIGS. 1 to 4B, the first positive terminal and the first negative terminal may be respectively disposed on the first surface of the electrode assembly, may be connected to the first positive electrode lead portion 121a and the first negative electrode lead portion 122a, respectively, and may be disposed to cover the first positive electrode lead portion 121a and the first negative electrode lead portion 122a to prevent at least portions thereof from being exposed externally.

In an example, an insulating member 141 may be disposed between the first positive terminal and the first negative terminal of the all-solid-state battery. The insulating member may be disposed over the entire region in which the first positive terminal and the first negative terminal face each other in the second direction. Since both the positive terminal and the negative terminal are disposed on the first surface of the electrode assembly, the insulating member may function to prevent a short circuit. The insulating member may include the same component as the above-described insulating member.

The positive terminal 131 and the negative terminal 132 may be formed by, for example, coating a terminal electrode paste containing a conductive metal on the lead-out portions of the positive electrode layer 121 and the negative electrode layer 122 or by applying a paste or powder for terminal electrodes on the positive electrode layer 121 and the negative electrode layer 122 of the battery body 110 and sintering the same by induction heating or the like. The conductive metal may be at least one conductive metal among, for example, copper (Cu), nickel (Ni), tin (Sn), palladium (Pd), platinum (Pt), gold (Au), silver (Ag), tungsten (W), titanium (Ti), lead (Pb), and alloys thereof, but is not limited thereto.

In an example, the all-solid-state battery 100 according to an embodiment may further include a plating layer (not illustrated) disposed on the positive terminal 131 and the negative terminal 132, respectively. The plating layer may include at least one selected from the group consisting of copper (Cu), nickel (Ni), tin (Sn), palladium (Pd), platinum (Pt), gold (Au), silver (Ag), tungsten (W), titanium (Ti), lead (Pb) and alloys thereof, but is not limited thereto. The plating layer may be formed of a single layer or a plurality of layers, and may be formed by sputtering or electrolytic plating (Electric Deposition), but the formation method is not limited thereto.

In another embodiment of the present disclosure, the positive electrode layer 121 and the negative electrode layer 122 of the all-solid-state battery are led out to the third and fourth surfaces of the electrode assembly, respectively, and the electrode assembly may include the first positive electrode lead portion 121a and the first negative electrode lead portion 122a led out to the first surface, and may include a second positive electrode lead portion 221b and a second negative electrode lead portion 222b led out to the second surface. In addition, a second positive terminal disposed on the second positive electrode lead portion 221b and a second negative terminal disposed on the second negative electrode lead portion 222b may be included.

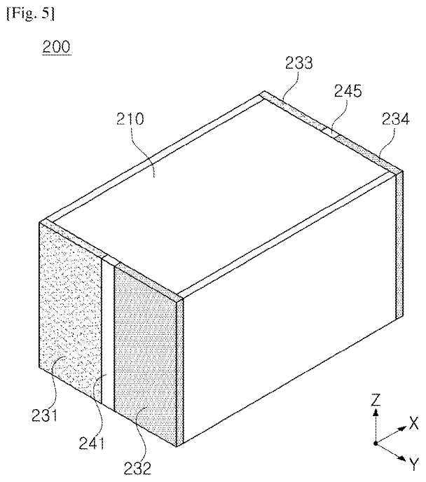

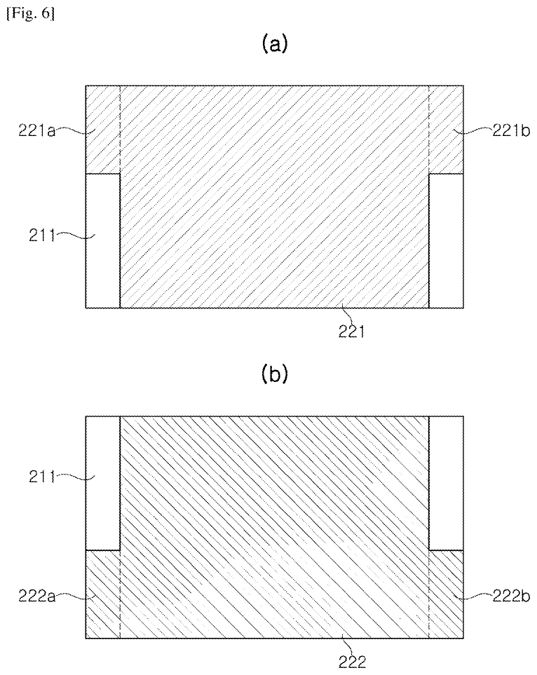

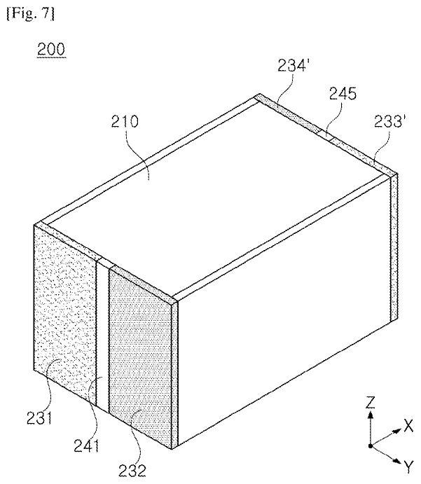

FIGS. 5 to 6B are views schematically illustrating an all-solid-state battery according to this embodiment. Referring to FIGS. 5 to 6B, in the all-solid-state battery according to an embodiment, a positive terminal and a negative terminal may be disposed on each of two surfaces in the first direction. In detail, the first positive electrode lead portion 221a and the first negative electrode lead portion 222a are led out to the first surface of the electrode assembly, and the second positive electrode lead portion 221b and the second negative electrode lead portion 222b are led out to the second surface of the electrode assembly. The first positive terminal and the first negative terminal may be disposed on the first positive electrode lead portion 221a and the first negative electrode lead portion 222a, respectively, and the second positive terminal and the second negative terminal may be disposed on the second positive electrode lead portion 221b and the second negative electrode lead portion 222b, respectively.

In an example, the first positive electrode lead portion 221a and the second positive electrode lead portion 221b of the all-solid-state battery may be led out from an area adjacent to the fourth surface of the electrode assembly, and the first negative electrode lead portion 222a and the second negative electrode lead portion 222b may be led out from an area adjacent to the third surface of the electrode assembly. Referring to FIGS. 5 to 6B, the first positive electrode lead portion 221a and the second positive electrode lead portion 221b may be led out from a region biased toward the fourth surface of the electrode assembly, and the second positive electrode lead portion 221b and the second negative electrode lead portion 222b may be led out from a region biased toward the third surface of the electrode assembly. For example, lead portions of the same polarity may be led out on the same X-axis line, and terminals of the same polarity may be disposed thereon.

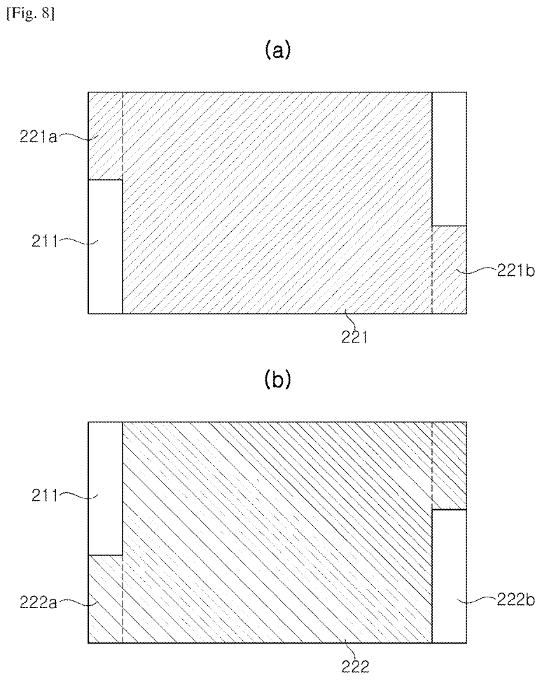

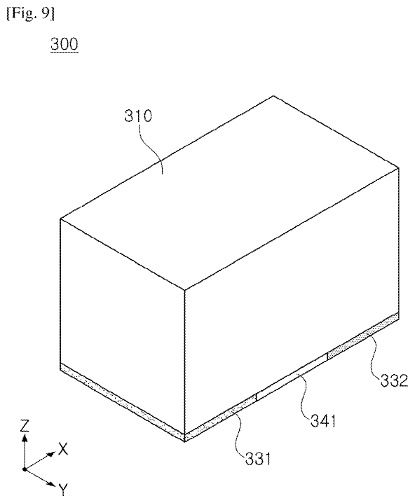

In another example, the first positive electrode lead portion 221a and the second negative electrode lead portion 222b of the all-solid-state battery are led out from a region adjacent to the fourth surface of the electrode assembly, and the first negative electrode lead portion 222a and the second positive electrode lead portion 221b may be led out from a region adjacent to the third surface of the electrode assembly. Referring to FIGS. 7 to 8B, the first positive electrode lead portion 221a and the second negative electrode lead portion 222b may be led out from a region biased toward the fourth surface of the electrode assembly, and the first negative electrode lead portion 222a and the second positive electrode lead portion 221b may be led out from a region biased toward the third surface direction of the electrode assembly. For example, lead portions of different polarities may be led out on the same X-axis line, and terminals of different polarities may be disposed thereon.

In an example of the present disclosure, the average width of the positive electrode lead portion of the all-solid-state battery according to an embodiment in the second direction may be in the range of 10% or more and/or less than 50% of the average width of the battery body in the second direction. In this specification, the “width” of a member may indicate a shortest vertical distance thereof measured in a direction parallel to the second direction, and the “average width” of a member may indicate an arithmetic mean of widths measured at points thereof divided into 10 equal intervals in the third direction of the member, with respect to a cross section (Y-Z plane) cut in the direction perpendicular to the X axis while passing through the center of the all-solid-state battery. In the all-solid-state battery according to an embodiment, the average width of the positive electrode lead portion in the second direction satisfies the range of 10% or more and/or less than 50% of the average width of the battery body in the second direction, thereby preventing short circuits while maintaining excellent connectivity of the positive electrode layer 121 and the positive electrode lead portion.

In another example of the present disclosure, the average width of the negative electrode lead portion of the all-solid-state battery according to an embodiment, in the second direction, may be in the range of 10% or more and/or less than 50% of the average width of the battery body in the second direction. In the all-solid-state battery according to an embodiment, the average width of the negative electrode lead portion in the second direction satisfies the range of 10% or more and/or less than 50% of the average width of the battery body in the second direction, thereby preventing short circuits or the like while maintaining excellent connectivity of the negative electrode layer 122 and the negative electrode lead portion.

In another example of the present disclosure, the battery body of the all-solid-state battery according to an embodiment may include a plurality of positive electrode layers 121 and/or a plurality of negative electrode layers 122. The all-solid-state battery according to an embodiment may include two or more of each of the positive electrode layer 121 and the negative electrode layer 122, and the positive electrode layer 121 and the negative electrode layer 122 may be alternately stacked on each other, with a solid electrolyte layer interposed therebetween. When a plurality of positive electrode layers 121 and/or a plurality of negative electrode layers 122 are disposed as in this example, a relatively high charging/discharging rate and high capacitance may be implemented.

In another embodiment of the present disclosure, an all-solid-state battery may include a battery body having first and second surfaces opposing each other in a first direction, third and fourth surfaces opposing each other in a second direction, and fifth and sixth surfaces opposing each other in a third direction, the battery body including a solid electrolyte layer, and an electrode assembly in which a positive electrode layer 321 and a negative electrode layer 322 are stacked in a second direction with the solid electrolyte layer interposed therebetween; a third positive terminal connected to the positive electrode layer 321; and a third negative terminal connected to the negative electrode layer 322. The third positive terminal may be disposed on the sixth surface of the electrode assembly. The third negative terminal may be disposed on the sixth surface of the electrode assembly to be spaced apart from the third positive terminal. The positive electrode layer 321 may include a third positive electrode lead portion 321a that extends from the positive electrode layer 321 and is connected to the third positive terminal on the sixth surface of the electrode assembly. The negative electrode layer 322 may include a third negative electrode lead portion 322a that extends from the negative electrode layer 322 and is connected to the third negative terminal on the sixth surface of the electrode assembly.

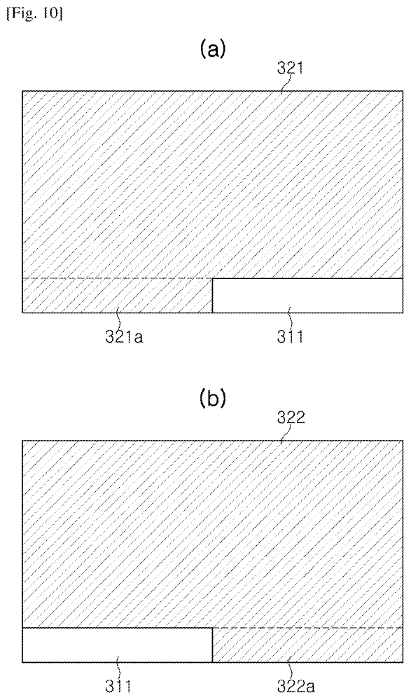

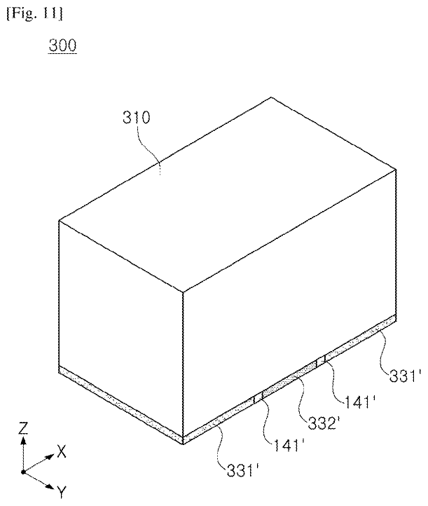

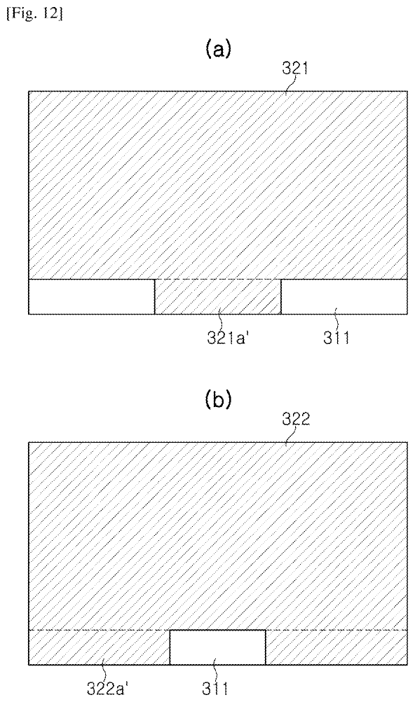

FIGS. 9 to 12B are views schematically illustrating an all-solid-state battery according to this embodiment. Referring to FIGS. 9 to 12B, the battery body of the all-solid-state battery may include an insulating member disposed on the first to fourth surfaces of the electrode assembly.

Also, the third positive terminal 331 may be disposed to cover at least a portion of the third positive electrode lead portion 321a, and the third negative terminal 332 may be disposed to cover at least a portion of the third negative electrode lead portion 322a.

In an example of the present disclosure, the negative electrode layer of the all-solid-state battery includes at least two or more third negative electrode lead portions 322a′, and the plurality of third negative electrode lead portions 322a′ are spaced apart from each other in the first direction. The third positive electrode lead portion 321a′ may be disposed between the third negative electrode lead portions 322a′.

In addition, an insulating member 341 may be disposed between the third positive terminal and the third negative terminal.

Descriptions of the positive electrode layer, the positive electrode lead portion, the positive terminal, the negative electrode layer, the negative electrode lead portion, the negative terminal, the solid electrolyte layer, and the insulating member are the same as described above, and thus will be omitted.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. An all-solid-state battery comprising:
a battery body having first and second surfaces opposing each other in a first direction, third and fourth surfaces opposing each other in a second direction, and fifth and sixth surfaces opposing each other in a third direction, the battery body including a solid electrolyte layer, and an electrode assembly in which a positive electrode layer and a negative electrode layer are stacked in the third direction with the solid electrolyte layer interposed therebetween;
a first positive terminal connected to the positive electrode layer; and
a first negative terminal connected to the negative electrode layer, wherein the first positive terminal is disposed on the first surface of the electrode assembly,
the first negative terminal is disposed on the first surface of the electrode assembly and spaced apart from the first positive terminal, the positive electrode layer includes a first positive electrode lead portion extending from the positive electrode layer and connected to the first positive terminal on the first surface of the electrode assembly, and
the negative electrode layer includes a first negative electrode lead portion extending from the negative electrode layer and connected to the first negative terminal on the first surface of the electrode assembly.

2. The all-solid-state battery of claim 1, wherein the positive electrode layer and the negative electrode layer are respectively led out to the second to fourth surfaces of the electrode assembly, and
the first positive electrode lead portion and the first negative electrode lead portion are led out to the first surface of the electrode assembly.

3. The all-solid-state battery of claim 2, wherein the battery body further includes an insulating member disposed on the second surface, the third surface, and the fourth surface of the electrode assembly.

4. The all-solid-state battery of claim 3, wherein the insulating member is disposed to completely cover at least the positive electrode layer and the negative electrode layer led out to the second to fourth surfaces of the electrode assembly.

5. The all-solid-state battery of claim 1, wherein the first positive terminal is disposed to cover at least a portion of the first positive electrode lead portion, and
the first negative terminal is disposed to cover at least a portion of the first negative electrode lead portion.

6. The all-solid-state battery of claim 1, further comprising an insulating member disposed between the first positive terminal and the first negative terminal.

7. The all-solid-state battery of claim 1, wherein the positive electrode layer and the negative electrode layer are led out to the third side and the fourth surface of the electrode assembly, respectively, and
the electrode assembly includes the first positive electrode lead portion and the first negative electrode lead portion led out to the first surface,
and a second positive electrode lead portion and a second negative electrode lead portion led out to the second surface,
wherein the all-solid-state battery further comprises a second positive terminal disposed on the second positive electrode lead portion and a second negative terminal disposed on the second negative electrode lead portion.

8. The all-solid-state battery of claim 7, wherein the first positive electrode lead portion and the second positive electrode lead portion are led out from a region adjacent to the fourth surface of the electrode assembly, and
the first negative electrode lead portion and the second negative electrode lead portion are led out from a region adjacent to the third surface of the electrode assembly.

9. The all-solid-state battery of claim 7, wherein the first positive electrode lead portion and the second negative electrode lead portion are led out from a region adjacent to the fourth surface of the electrode assembly, and
the first negative electrode lead portion and the second positive electrode lead portion are led out from a region adjacent to the third surface of the electrode assembly.

10. An all-solid-state battery comprising:
a battery body having first and second surfaces opposing each other in a first direction, third and fourth surfaces opposing each other in a second direction, and fifth and sixth surfaces opposing each other in a third direction, the battery body including a solid electrolyte layer, and an electrode assembly in which a positive electrode layer and a negative electrode layer are stacked in the second direction with the solid electrolyte layer interposed therebetween;
a third positive terminal connected to the positive electrode layer; and a third negative terminal connected to the negative electrode layer,
wherein the third positive terminal is disposed on the sixth surface of the electrode assembly,
the third negative terminal is disposed on the sixth surface of the electrode assembly to be spaced apart from the third positive terminal, the positive electrode layer includes a third positive electrode lead portion extending from the positive electrode layer and connected to the third positive terminal on the sixth surface of the electrode assembly, and
the negative electrode layer includes a third negative electrode lead portion extending from the negative electrode layer and connected to the third negative terminal on the sixth surface of the electrode assembly.

11. The all-solid-state battery of claim 10, further comprising an insulating member disposed on the first to fourth surfaces of the electrode assembly.

12. The all-solid-state battery of claim 10, wherein the third positive terminal is disposed to cover at least a portion of the third positive electrode lead portion, and
the third negative terminal is disposed to cover at least a portion of the third negative electrode lead portion.

13. The all-solid-state battery of claim 10, wherein the negative electrode layer includes at least two or more third negative electrode lead portions,
wherein the at least two or more third negative electrode lead portions are disposed to be spaced apart from each other in the first direction, and
the third positive electrode lead portion is disposed between the third negative electrode lead portions.

14. The all-solid-state battery of claim 10, further comprising an insulating member disposed between the third positive terminal and the third negative terminal.

15. An all-solid-state battery comprising:
a battery body having first and second surfaces opposing each other in a first direction, third and fourth surfaces opposing each other in a second direction, and fifth and sixth surfaces opposing each other in a third direction, the battery body including a solid electrolyte layer, and an electrode assembly in which a positive electrode layer and a negative electrode layer are stacked in the third direction with the solid electrolyte layer interposed therebetween;
wherein the positive electrode layer includes a first positive electrode lead portion extending from the positive electrode layer to the first surface of the electrode assembly, the first positive electrode lead portion arranged to be connected to a first positive terminal, and the negative electrode layer includes a first negative electrode lead portion extending from the negative electrode layer to the first surface of the electrode assembly and spaced apart from the first positive electrode lead portion, the first negative electrode lead portion arranged to be connected to a first negative terminal.

16. The all-solid-state battery of claim 15, wherein the positive electrode layer and the negative electrode layer are respectively led out to the second to fourth surfaces of the electrode assembly.

17. The all-solid-state battery of claim 16, wherein the battery body further includes an insulating member disposed on the second surface, the third surface, and the fourth surface of the electrode assembly.

18. The all-solid-state battery of claim 17, wherein the insulating member is disposed to completely cover at least the positive electrode layer and the negative electrode layer led out to the second to fourth surfaces of the electrode assembly.

19. The all-solid-state battery of claim 15, further comprising the first positive terminal and the first negative terminal,
wherein the first positive terminal is disposed to cover at least a portion of the first positive electrode lead portion, and the first negative terminal is disposed to cover at least a portion of the first negative electrode lead portion.

20. The all-solid-state battery of claim 19, further comprising an insulating member disposed between the first positive terminal and the first negative terminal.

21. The all-solid-state battery of claim 19, wherein the positive electrode layer and the negative electrode layer are led out to the third side and the fourth surface of the electrode assembly, respectively, and
the electrode assembly includes the first positive electrode lead portion and the first negative electrode lead portion led out to the first surface, and a second positive electrode lead portion and a second negative electrode lead portion led out to the second surface,
wherein the all-solid-state battery further comprises a second positive terminal disposed on the second positive electrode lead portion and a second negative terminal disposed on the second negative electrode lead portion.
